(19) United States
(12) Patent Application Publication
(10) Pub. No.: US 2006/0112782 A1
(43) Pub. Date: Jun. 1, 2006

(54) Control module with improved return force

(76) Inventors: Laurent Tupinier, Reichstett (FR); Jean Giordano, Strasbourg (FR); Laurent Marcuzzi, St-Etienne (FR)

Correspondence Address: DELPHI TECHNOLOGIES, INC., M/C 480-410-202, PO BOX 5052, TROY, MI, 48007, US

(21) Appl. No.: 11/251,287

(22) Filed: Oct. 14, 2005

(30) Foreign Application Priority Data
Oct. 14, 2004 (EP) 04360091.5

(51) Int. Cl. F16H 35/00

(52) U.S. Cl. 74/842

(57) ABSTRACT

The present invention relates to a control module for activating and/or deactivating functionalities of an apparatus, a machine or a vehicle, which has:

control component (1) which can be manipulated by the user for the purpose of controlling at least one functionality,

haptic control device (2) making it possible t₁ generate a return force on the control component, the return force being antagonistic to the displacement of control component (1) and perceptible by the user,

characterized by the fact that it has a mechanical indexing means for returning and maintaining control component (1), in the absence of a manipulation of control component (1), in at least one predefined stable indexing position.

The present invention relates to the general technical domain of control modules for activating and/or deactivating functions or functionalities. Such modules are found, for example, on apparatuses, machines or vehicles. The present invention relates more particularly to controls underneath vehicle steering wheels which have such a control module.

These control modules can integrate or be associated with a known haptic control device.

A haptic control device enables one to give the operator of a control component, during activation or during deactivation, a predefined sensation by means of a force which is at least in part antagonistic to the action of the operator.

This antagonistic force is, for example, generated by a passive actuator driven by the haptic control device. A passive actuator is conveniently understood to mean any device or any means capable of generating a force opposing a movement, such as a brake, but without being capable of generating a movement, a displacement, or a rotation of a part or mechanism. An active actuator can be defined as a motor, which is capable of generating such a movement, displacement or rotation.

A known control module is produced for activating and/or deactivating functionalities of an apparatus, a machine or a vehicle, which has:

a control component which can be manipulated by the user for the purpose of controlling at least one functionality,

a haptic control device making it possible to generate a particular return force on the control component, the return force being antagonistic to the displacement of the control component and perceptible by the user.

Problems are encountered with known control modules integrating a haptic control device of the passive actuator type. In effect, a passive actuator can only oppose the movement of the control component, and does not enable one to obtain an indexing position for the control component that is stable over time. The precision of the control component is thus affected.

Also known are mechanical indexing systems which induce a particular sensation for the operator of the control component. The mechanical systems are consequently specific to each product as a function of the desired sensation. For each different steering column top, one has specific structural characteristics and return force profile. The means generating the return pressure thus cannot be standardized for products, for example, for different steering column tops.

The aim of the present invention is to remedy the problems of the prior art and to produce a control module that generates an adjustable return force, whose fineness of adjustment makes it possible to approach to the best possible degree the sensations desired by the person operating the control module while avoiding the problems connected with a floating indexing position.

According to the invention, the control module has a mechanical indexing means for returning and maintaining the control component, without manipulation of the control component, in at least one predefined stable indexing position.

The use of a haptic control device, whose known advantage is the elimination of any mechanical system, is, in the context of the invention, associated with the use of a mechanical indexing system. Such an association makes it possible to obtain enormous technical and economic advantages in an unexpected manner.

Furthermore, the use of an active actuator of the motor type is not at all necessary for producing the control module according to the invention.

According to an embodiment, the haptic control device has a passive actuator which opposes the displacement of the control component.

The use of a passive actuator makes it possible to reduce the space requirement and the costs of a control module according to the invention.

According to an embodiment, the stable indexing rest position is a central or extreme position with respect to the displacements of the control component.

According to an embodiment, the indexing means is an elastic return means of the spring type, acted upon in order to automatically return the control component that has moved away from said stable indexing position to at least one stable indexing position.

The passive actuator is, for example, a means of braking of the electromagnetic brake type.

According to an embodiment, the control module has an indexing finger, on the one hand connected to the manipulation component via an elastic linking component, and on the other hand resting elastically, via the elastic linking component, on a fixed indexing surface of the relief type, defining at least one stable position and at least one unstable position for the control component, according to a degree of freedom distinct from that associated with the passive actuator.

According to an embodiment, the haptic control device on the one hand has means for navigating menus, each corresponding to a particular return pressure curve, and on the other hand, means for selecting one of said menus.

According to an embodiment, the control module has, for example, display means for displaying the different menus.

The control module according to the invention has means for recording the menu selected.

According to an embodiment, the control module has at least one position sensor respectively determining the position of the control component, the values of the physical parameters thus determined being transmitted to a microcontroller which controls the passive actuator with the help of the selected menu.

According to another embodiment, the control module also has a force sensor determining the force applied by the user on the control component, the values of the physical parameters thus determined being transmitted to a microcontroller which controls the passive actuator with the help of the selected menu.

The force and position sensors can be combined in a control module according to the invention.

The control module advantageously has a means of connection for establishing a link with an adjustment module which defines the profiles of the return pressure curves recorded in the menus.

The present invention also relates to a control underneath vehicle steering wheel which has a control module as presented above.

Other characteristics and advantages will emerge from the detailed description given hereafter in reference to the appended drawings, given as non-limiting examples, in which:

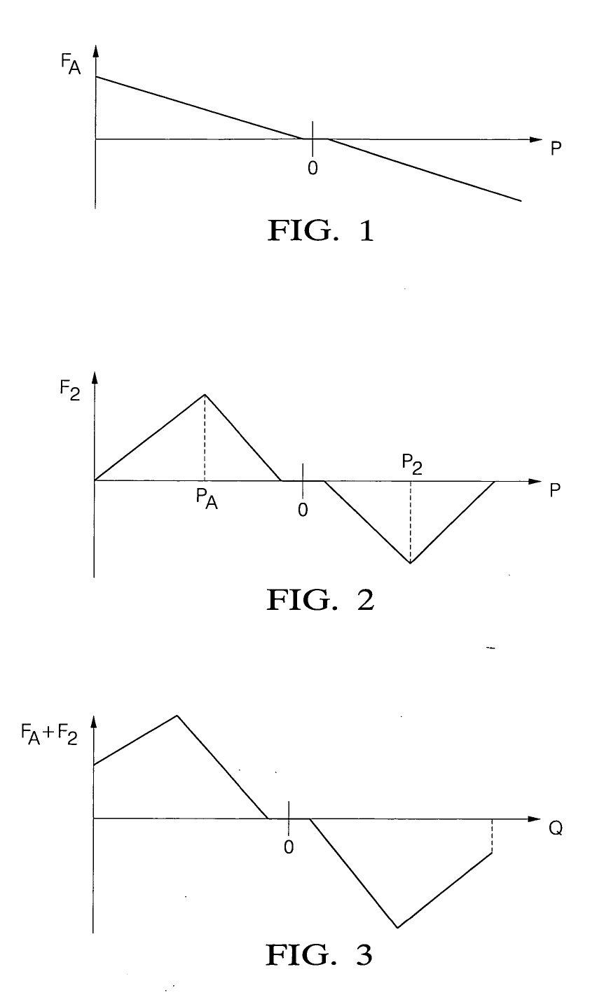

FIG. 1 is an example of a curve of return force generated by an elastic system, as a function of the position of a manipulation component of a control module according to the invention,

FIG. 2 is an example of a curve of return force generated by a passive actuator, as a function of the position of a manipulation component of a control module according to the invention,

FIG. 3 represents an example of a curve of return force generated by the association of a passive actuator with an elastic system, as a function of the position of a manipulation component of a control module according to the invention,

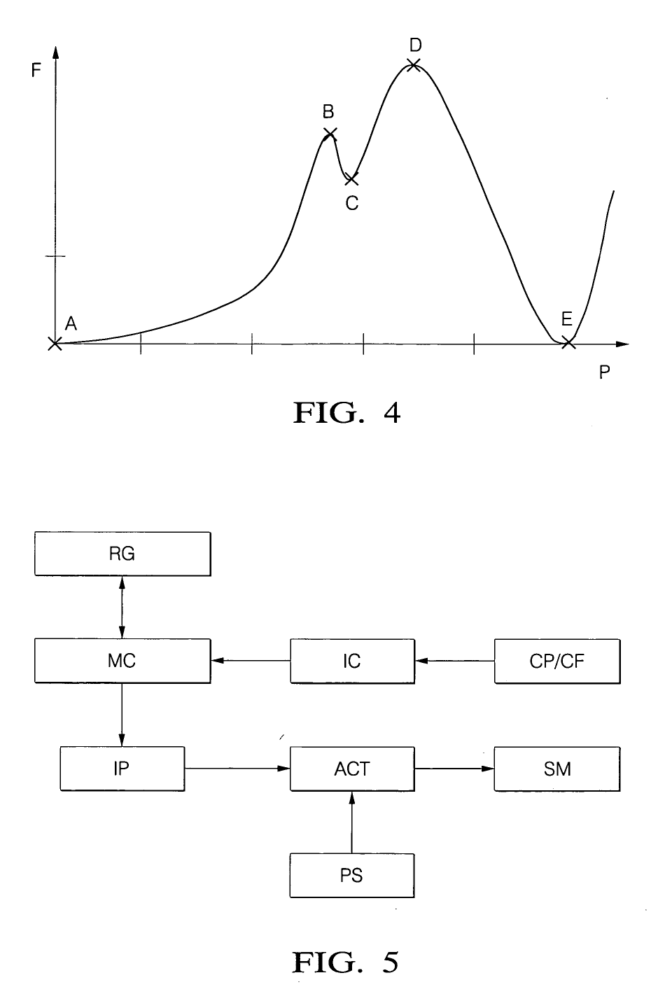

FIG. 4 is another example of a curve of return force generated by a module integrating a haptic feedback device,

FIG. 5 diagrammatically represents an example of interaction between the constitutive elements of an example of a control module according to the invention,

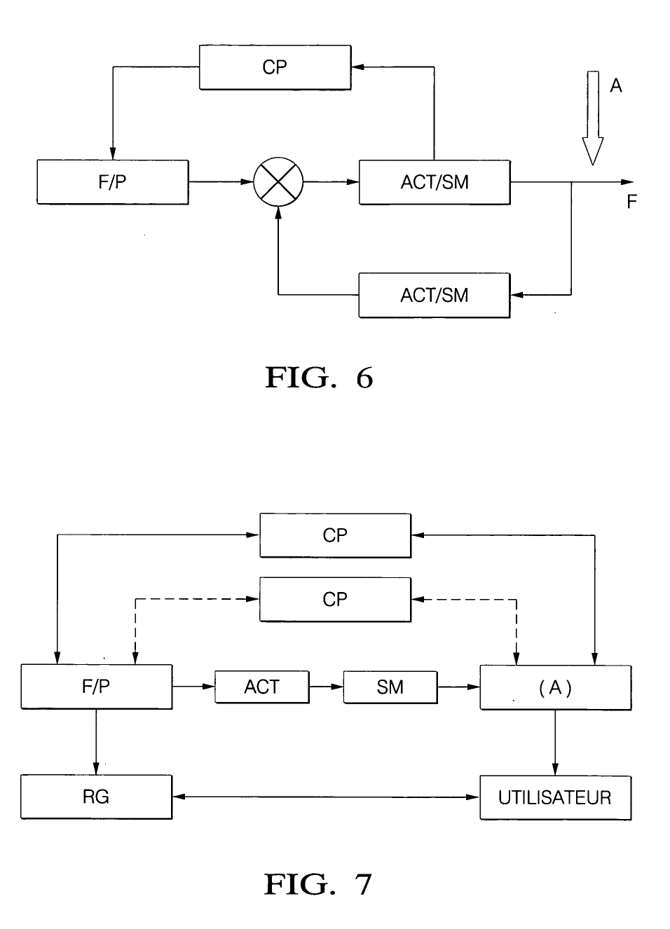

FIG. 6 diagrammatically represents an example of automatic control of a control module according to the invention,

FIG. 7 represents a functional interaction diagram of an example of a control module according to the invention,

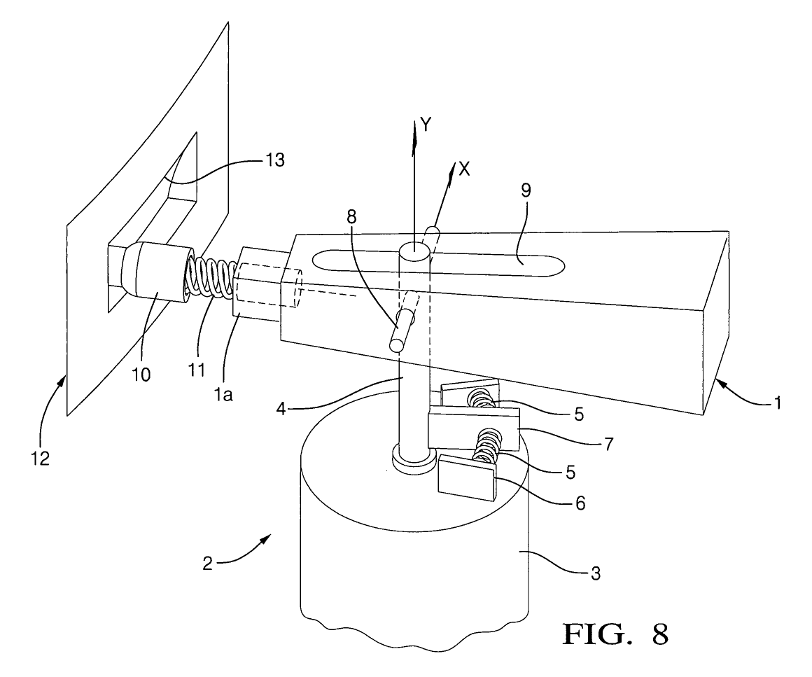

FIG. 8 represents an embodiment of a control module according to the invention.

A control module for activating and/or deactivating functionalities of an apparatus, and more particularly, of a vehicle, will be described in more detail.

The control module according to the invention corresponds, for example, to a control underneath the steering wheel, an embodiment of which is represented in FIG. 8. The control module has control component (1) which can be manipulated by the user for the purpose of controlling at least one functionality. Control component (1) is, for example, a lever which can be shifted by pivoting with respect to a first direction X and with respect to a second direction Y. These two pivoting directions X and Y are, for example, perpendicular to one another.

The control module also has haptic control device (2) making it possible to generate a specific return force on control component (1).

Haptic control device (2) is known. It makes it possible to generate a return force which can be perceived by the user and which depends, for example, on the selected functionality. Functionality is suitably understood to mean starting or stopping a function of a vehicle, as well as increasing or decreasing, for example, an intensity or physical parameter or amplitude of displacement of a constitutive element of the vehicle.

Haptic control device (2) has casing (3) in which an actuator (not represented) is arranged. Drive pin (4) projecting out of casing (3) connects the actuator to control component (1). Haptic control component (2) has, for example, a passive actuator which opposes the displacement of control component (1).

Thus the actuator, for example, a motor or a brake, can, by the force that it generates, oppose the rotation of pin (4) imparted by control component (1), and this when the user is operating said control component (1) around the second pivoting direction Y.

The control module also has a mechanical indexing means for returning and maintaining control component (1), in the absence of a manipulation of control component (1), in at least one predefined stable indexing position. This allows control component (1) to automatically regain its indexing position when the user is not exerting any action on said control component (1).

The indexing means has, for example, an elastic return means which opposes an applied movement, inducing the automatic return of control component (1) to at least one stable indexing position. The elastic return means entails at least one spring (5), one end of which is connected to fixed stop (6) connected to casing (3), and the other end of which is connected to mobile stop (7) connected to drive pin (4).

The example represented in FIG. 8 has two fixed stops (6) and a central mobile stop (7) as well as two springs (5) connecting each fixed stop (6) to mobile stop (7). The latter is connected to drive pin (4) and makes it possible to define a stable indexing position when the action of the two springs (5) is balanced. The indexing position is therefore a stable rest position for control component (1). The latter, when it is pivoted around the second pivoting direction Y, automatically returns to its stable indexing position when the user is no longer exerting any action on said control component (1). The stable indexing position therefore corresponds to at least one fixed position of drive pin (4) with respect to casing (3), As represented in FIG. 8, the rest position is a central position with respect to the displacement of control component (1), which can thus be pivoted in the clockwise or counterclockwise direction. The stable indexing position can also correspond to an extreme rest position with respect to the displacement of control component (1), that is to say, at the end of travel.

According to another embodiment, it is possible to envision producing a control module whose control component (1) has a series of several successive indexing positions.

In order to increase the functionalities accessible by means of control component (1), it is also possible to envision a pivoting of the latter around the first pivoting direction X, and this via additional shaft (8). The latter advantageously runs through drive pin (4).

In order to allow control component (1) to pivot around additional pivot shaft (8), central recess (9) that is traversed by pivot pin (4) is provided in said control component (1).

Other technical embodiment variants can also be envisioned to allow control component (1) to pivot according to the pivoting directions X and Y, perpendicular to one another, without departing from the scope of the present invention.

According to an embodiment, the control module according to the invention has indexing finger (10), on the one hand connected to the control component via an elastic linking component, and on the other hand resting elastically by means of the elastic linking component on fixed indexing surface (12), of the relief (13) type, defining at least one stable position and at least one unstable position for control component (1), according to a degree of freedom distinct from that associated with the passive actuator.

Elastic linking component (11) is, for example, a spring which connects indexing finger (10) to mounting end (1a) of control component (1). Indexing surface (12) advantageously has relief (13) which defines at least one stable indexing position compatible with the stable indexing position defined by springs (5) and fixed stops (6) and mobile stop (7). In such an embodiment, the return pressure generated by the passive actuator takes into account the specific return pressure which can relate to indexing finger (12), in order not to alter the sensation of the operator of control component (1).

Control component (1) can also be a keypad of the pushbutton type, or a sliding switch of the slider type, or a wheel, without departing from the scope of the invention.

FIG. 1 represents, for example, a curve of return force (F₁) generated by an elastic return means of the spring type. The curve represented shows the return force (F₁), with respect to position (P) of control component (1) on both sides of a central rest position (O).

FIG. 2 represents an example of a curve of return force (F₂) generated by a passive actuator of haptic control device (2). Force (F₂) is represented as a function of position (P) of control component (1). Springs (5) of the indexing device make it possible to generate a force comparable to that diagrammed in FIG. 1. By associating this return force with that generated by haptic control device (2) (cf. FIG. 2), the curve of return force (F) diagrammed in FIG. 3 is obtained.

In this example of return force (F), the combination of the effect of an elastic return means with the effect of a passive actuator makes it possible to maintain central indexing position O, on the one hand, and to return control component (1) to its stable central indexing position regardless of its position (P) corresponding to its course of displacement. In effect, when control component (1) is moved to an extreme position, there is always a sufficient return force to return it to central indexing position O. Furthermore, the use of a passive actuator makes it possible to modify the force generated on control component (1) and thus to modify the sensation experienced by the user when he operates said control component (1).

The control module according to the invention has, for example, a means of connection for establishing a link with an adjustment module, which defines the profiles of the curves of return pressure recorded in the menus. As a variant, the transfer of data and/or of instructions between the adjustment module and the control module can also occur by means of a known wireless link.

According to an embodiment, the control module has position sensor (CP) and force sensor (CF), respectively judging the position of control component (1) and the force applied to the latter by the user. The values of the physical parameters thus determined are transmitted to microcontroller (MP) which controls the passive actuator with the help of the selected menu.

According to another embodiment, the control module has position sensor (CP) only, in order to apply an instruction without verification of the force applied to control component (1). The measuring and control means are then simplified.

Haptic control device (2) advantageously has some means, on the one hand, for navigating in menus, each corresponding to a particular curve of return pressure, and on the other hand, for selecting one of said menus. The control module furthermore has some means for recording the menu selected by the user. It is therefore possible, with a given control module according to the invention, to satisfy the different and varied wishes concerning return pressure, coming, for example, from the builders of steering column tops.

The adjustment module preferably has some means for determining and selecting a curve of return force (F), an example of a profile of which is represented in FIG. 4. For this purpose, the adjustment module has some means for determining characteristic points A, B, C, D, E of a curve of return force or pressure, essentially reflecting the desired sensation for the user, and some computation means for determining the curve passing through these characteristic points A, B, C, D, E. This return pressure is transmitted to control component (1) by means of the passive actuator.

One can refer, for example, to FIG. 4 representing an example of a curve of return pressure (F) and characteristic points A, B, C, D, E relating to it. The curve of FIG. 4 represents the curve of return pressure (F) as a function of position (P) of control component (1). The computation means, for example, microcontroller (MP), make it possible to determine the curve passing through the characteristic points A, B, C, D, E using a mathematical model. This model makes it possible, for example, to determine the polynomial passing through the characteristic points A, B, C, D, E and to calculate the derivative of this polynomial going to zero at these characteristic points A, B, C, D, E.

The control module also has means for shifting one or more characteristic points A, B, C, D, E, thus refining the shape of the curve of return pressure (F) and the desired sensations for the user.

Advantageously, the adjustment module has some means of graphic representation (RG) showing the position of the characteristic points and the computed curve of return pressure (F) passing through the characteristic points A, B, C, D, E. Means of graphic representation (RG) allow the user, and more precisely when adjusting the control module, to display the characteristic points and the corresponding curve. Means of graphic representation (RG) also allow the user to intervene in order to modify the position of one or more of said characteristic points. The means of graphic representation can also be used to run through the various accessible menus, thus replacing the display means of the control module. Once the suitable menu is selected and recorded, the user no longer needs to adjust the control module.

The control module then records, via the microcontroller, the computed curve of pressure (F) corresponding to the sensations desired by the user.

According to an embodiment, the computation means make it possible to define ranges of position for control component (1) with which corresponding mathematical functions (polynomials) are associated so as to define, for each range, a complex profile of the rule of return pressure. The sequence of profiles is then juxtaposed in order to form the curve of return pressure (F) for all of positions (P) that can be accessed by control component (1).

The user may thus be confronted with different and varied sensations corresponding, for example, to pressures of varying strength that must be overcome during pivoting of control (1) as a function of position (P) of the latter.

FIG. 5 diagrammatically represents an example of interaction between the constitutive elements of a control module according to the invention. The control module thus has mechanical system (SM), which includes control component (1) as well as position (CP) and force (CF) sensors which transmit the information measured on mechanical system (SM), via sensor interface (IC), to microcontroller (MC). The latter, by means of graphic representation (RG) and a graphic interface, makes it possible on the one hand to display the characteristic points A, B, C, D, E and the curve of return pressure relating to them, and on the other hand to intervene in order to modify the positioning of said characteristic points.

Power interface (IP) allows microcontroller (MC) to control passive actuator (ACT). The latter, thanks to power supply (PS), makes it possible to apply a force (F) or a pressure to mechanical system (SM).

Means of graphic representation (RG) can include a screen allowing the user, proceeding with the adjustment of the control module, to display the position of the characteristic points A, B, C, D, E and to choose the number of characteristic points.

With reference to FIG. 6, which diagrammatically represents an example of automatic control of a control module according to the invention, following an action (A) by the user on control component (1), there is, for example, a measurement of position (P) of control component (1) via position sensor (CP), as well as a measurement of the force applied to said control component (1) by the user, via force sensor (CF). The measurement of force via force sensor (CF) can be direct or indirect. When it is a direct measurement of force, the force applied to control component (1) is measured directly, and when it is an indirect measurement, a physical magnitude is measured, for example, an intensity or a speed of rotation of the actuator, which is an image of the intensity of the force applied to control component (1).

The position of control component (1) allows microcontroller (MC) to determine the intensity of the force of the return pressure to be applied via actuator (ACT), thanks to the curve of pressure (F), and as a function of the displacement (P), recorded in the control module.

Microcontroller (MC) then makes it possible to modulate the information given to actuator (ACT) in order to apply a particular pressure on control component (1) as a function of the information coming from force sensor (CF) measuring the operating force of the user. This advantageously makes it possible to take into account possible reactions of control component (1) connected with friction, play or other imperfections of the mechanism, and to not influence the sensation desired by the user with the return pressure.

An example of a functional diagram of a control module according to the invention is represented, for example, in FIG. 7. Position sensor (CP) and force sensor (CF) directly transmit information coming from control component (1) to microcontroller (MC). The latter controls actuator (ACT) which generates the return force (F) on mechanism (SM) in which control component (1) is arranged. Mechanism (SM) therefore transmits this force to control component (1), which thus constitutes the interface between the user and mechanism (SM).

The user acts on the adjustment module in order to modify the information computed and recorded in microcontroller (MC). Means of graphic representation (RG) and the adjustment module, if applicable, are disconnected from microcontroller (MC) when the curve of return pressure (F) has the desired profile and the sensation of return pressure experienced by the user corresponds to his expectations. This curve, which moreover takes into account the parameters connected with construction of the control module and of the support for which it is intended, for example, a steering column top, is recorded by means of microcontroller (MC).

1. A control module for activating and/or deactivating functionalities of an apparatus, a machine or a vehicle, which has:
control component (1) which can be manipulated by the user for the purpose of controlling at least one functionality,
haptic control device (2) making it possible to generate a return force on the control component, the return force being antagonistic to the displacement of control component (1) and perceptible by the user, characterized by the fact that it has a mechanical indexing means for returning and maintaining control component (1), in the absence of a manipulation of control component (1), in at least one predefined stable indexing position.

2. A control module according to claim 1, characterized by the fact that haptic control device (2) has a passive actuator which opposes the displacement of control component (1).

3. A control module according to claim 1 or 2, characterized by the fact that the indexing means is an elastic return means of the spring (5) type, acted upon in order to automatically return, to at least one stable indexing position, control component (1) which has moved away from said stable indexing position.

4. A control module according to claim 2, characterized by the fact that the passive actuator is a braking means of the electromagnetic brake type.

5. A control module according to any one of claims 1 to 4, characterized by the fact that the stable indexing rest position is a central or extreme position with respect to the displacements of control component (1).

6. A control module according to any one of claims 2 to 5, characterized by the fact that it has indexing finger (10), on the one hand connected to the control component (1) via elastic linking component (11), and on the other hand resting elastically, thanks to the elastic linking component, on fixed indexing surface (12), of the relief (13) type, defining at least one stable position and at least one unstable position for control component (1), according to a degree of freedom distinct from that associated with the passive actuator.

7. A control module according to any one of claims 1 to 6, characterized by the fact that haptic control device (2) has, on the one hand, means for navigating in menus, each corresponding to a particular curve of return pressure, and on the other hand, means for selecting one of said menus.

8. A control module according to claim 7, characterized by the fact that it has some means for recording the selected menu.

9. A control module according to claim 7 or 8, characterized by the fact that it has at least some display means (RG) to display at least the different menus.

10. A control module according to any one of claims 7 to 9, characterized by the fact that it has position sensor (CP) judging the position of control component (1), the values of the physical parameters thus determined being transmitted to microcontroller (MC), which controls the passive actuator with the help of the selected menu.

11. A control module according to claim 10, characterized by the fact that it has force sensor (CF) judging the force applied by the user on control component (1), the values of the physical parameters thus determined being transmitted to microcontroller (MC), which controls the passive actuator with the help of the selected menu.

12. A control module according to claim 8, characterized by the fact that it has a means of connection for establishing a link with an adjustment module which defines the profiles of the curves of return pressure recorded in the menus.

13. A control underneath the steering wheel of a vehicle, which has a control module according to any of claims 1 to 12.
